(19) United States
(12) Patent Application Publication
(10) Pub. No.: US 2024/0068668 A1
(43) Pub. Date: Feb. 29, 2024

(54) Gas valve arrangement and gas stove

(71) Applicant: BSH Hausgeräte GmbH, Munich (DE)

(72) Inventors: Emilio Placer Maruri, Liencres (ES); Mario Velo Bezanilla, Santander (ES)

(21) Appl. No.: 18/269,788

(22) PCT Filed: Jan. 13, 2022
(86) PCT No.: PCT/EP2022/050627

§ 371 Date: Jun. 27, 2023

(30) Foreign Application Priority Data
Jan. 28, 2021 (EP) 21382067.3

(51) Int. Cl. F24C 3/12

(52) U.S. Cl. CPC F24C 3/12

(57) ABSTRACT

A gas valve arrangement for a gas stove, comprising a gas valve, which has a gas inlet and a gas outlet, and a manifold device for redirecting a flow of combustion gas from the gas outlet by 90°, wherein the manifold device is attached to the gas outlet solely by means of friction.

The present invention relates to a gas valve arrangement for a gas stove and to a gas stove with such a gas valve arrangement.

A gas stove comprises one or more gas burners and a gas valve for regulating a flow of combustion gas to the gas burner. Each gas burner has a gas valve. The gas valve has an actuation stem that can be rotated to actuate the gas valve. A knob is mounted on the actuation stem. The gas valve further has a gas outlet for providing a flow of combustion gas to the gas burner. Gas stoves can either have their knobs on a top of the gas stove or on a front thereof. Gas stoves with the knobs on top need gas valves with the gas outlet being oriented toward the actuation stem in an angle of 90°. Gas stoves with the knobs on the front need gas valves with the gas outlet being oriented toward the actuation stem in an angle of 180°. This means that different types of gas valves are needed for different types of gas stoves. However, it is desirable to use one type of gas valve for different types of gas stoves.

It is one object of the present invention to provide an improved gas valve arrangement for a gas stove.

Accordingly, a gas valve arrangement for a gas stove is provided. The gas valve arrangement comprises a gas valve, which has a gas inlet and a gas outlet, and a manifold device for redirecting a flow of combustion gas from the gas outlet by 90°, wherein the manifold device is attached to the gas outlet solely by means of friction.

Since the manifold device redirects the flow of combustion gas by 90°, it is possible to use a certain type of gas valve for different types of gas stoves. Development times and costs can be reduced. One solution for the gas valve can be used for different product variants of the gas stove.

The gas valve preferably is a gas regulating valve which is configured to regulate the flow of combustion gas from a main gas pipe to a gas burner. In particular, the gas valve is a so-called step valve. “Redirecting” the flow of combustion gas means that the combustion gas is deflected or rerouted when coming from the gas outlet. The gas outlet is tube-shaped. The manifold device can be at least partly arranged within the gas outlet. “90°” in this context means “perpendicular”. “90°” or “perpendicular” in the present context also includes values of 90°±10°, preferably of 90°±5°, more preferably of 90°±3°, more preferably of 90°±1°, more preferably of exactly 90°.

That the manifold device is attached to the gas outlet “solely” or “exclusively” by means of friction means that no other type of connection, for example a screw connection or an adhesive connection, is provided. The connection between the manifold device and the gas outlet is just a frictionally engaged connection. For example, the manifold device is plugged into the gas outlet without any tools. Thus, the manifold device can be mounted to the gas outlet tool-free or tool-less.

According to an embodiment, the gas valve comprises an actuation stem for actuating the gas valve, wherein the actuation stem and the gas outlet are arranged perpendicular to each other.

The actuation stem can be rotated to actuate the gas valve. A knob can be mounted on the actuation stem.

According to a further embodiment, the gas valve arrangement further comprises a manifold which is configured to redirect the flow of combustion gas by 90°.

The manifold can be made from metal, for example from a steel or aluminum alloy. However, the manifold can also be made of a plastic material. The manifold can be formed integrally. The manifold can be named elbow.

According to a further embodiment, the manifold comprises a fastening section, to which a tube can be connected, and a connection section, which is at least partly received in the gas outlet, wherein the fastening section and the connection section are arranged perpendicular to each other.

The fastening section is cylinder-shaped. The connection section is tube shaped. The connection section can at least partly be received within the gas outlet.

According to a further embodiment, the fastening section has an outer thread.

A pipe or tube with a cap nut can thus be mounted to the fastening section. The tube guides the combustion gas to the gas burner. The tube can be an aluminum tubing.

According to a further embodiment, the connection section is smooth on an exterior surface thereof.

That means that the connection section has no thread or the like. The connection section is thus thread-free or thread-less. The exterior surface can be cylinder-shaped.

According to a further embodiment, the fastening section comprises a central bore, wherein the connection section comprises a central bore, and wherein the bores intersect each other.

Thus, the bores are fluidly connected to each other. The bores can have the same diameter. The bore of the fastening section can be a stepped bore.

According to a further embodiment, the manifold comprises a box-shaped base section with outer faces, wherein the fastening section protrudes from one of the outer faces, and wherein the connection section protrudes from another of the outer faces.

Preferably, there are provided six outer surfaces. The base section can be cube-shaped. Preferably, the face the fastening section protrudes from is adjacent the face the connection section protrudes from.

According to a further embodiment, the base section comprises an annular groove which runs around the connection section.

The annular groove has a bottom face that is set back behind the outer face from which the connection section protrudes. The tube-shaped gas outlet can be partly received in the annular groove.

According to a further embodiment, the valve arrangement further comprises a gasket which receives the connection section.

The gasket is plugged on the connection section. The gasket is connected to the connection section solely by means of friction. When plugging the gasket on the connection section, the gasket can be stretched radially.

According to a further embodiment, the gasket attaches the manifold device to the gas outlet solely by means of friction.

The gasket can be radially compressed between the connection section and the gas outlet.

According to a further embodiment, the gasket is made of a flexible material, in particular rubber.

The gasket can also be made of a thermoplastic elastomer (TPE), for example a thermoplastic polyurethane (TPU). Preferably, the gasket is formed integrally.

According to a further embodiment, the gasket comprises at least one ring section which runs around the gasket for sealing the gasket against the gas outlet.

The ring section preferably has a semicircular shape. There can be provided two ring sections which are spaced apart from each other when seen along an axis of symmetry of the gasket.

According to a further embodiment, the gasket comprises a flange section which runs around the gasket and which is at least partly received within the manifold.

The flange section is received in the annular groove of the base section of the manifold. The flange preferably lies against the bottom face of the annular groove.

Furthermore, a gas stove comprising such a gas valve arrangement is provided.

The gas stove is a household appliance. Thus, the gas stove can be named household gas stove. The gas stove can have a plurality of gas valve arrangements. There are provided four gas valve arrangements, for example.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

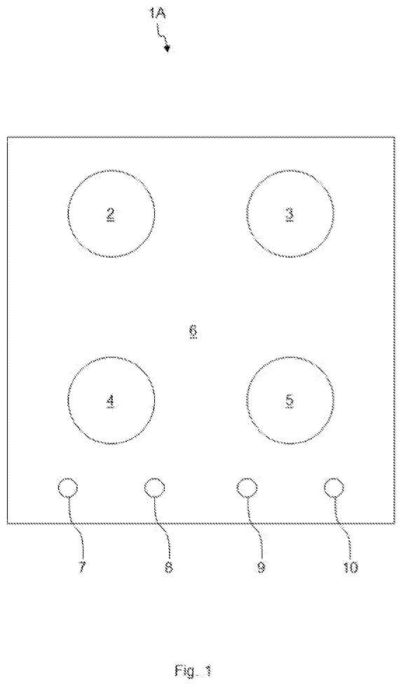

FIG. 1 shows a schematic top view of an embodiment of a gas stove;

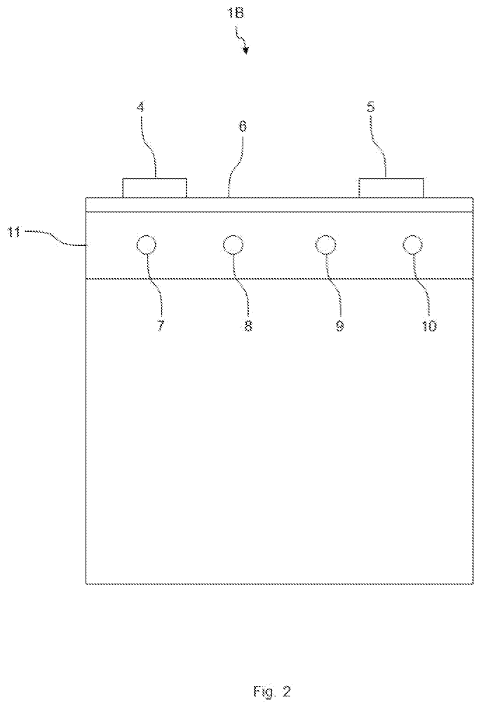

FIG. 2 shows a schematic front view of another embodiment of a gas stove;

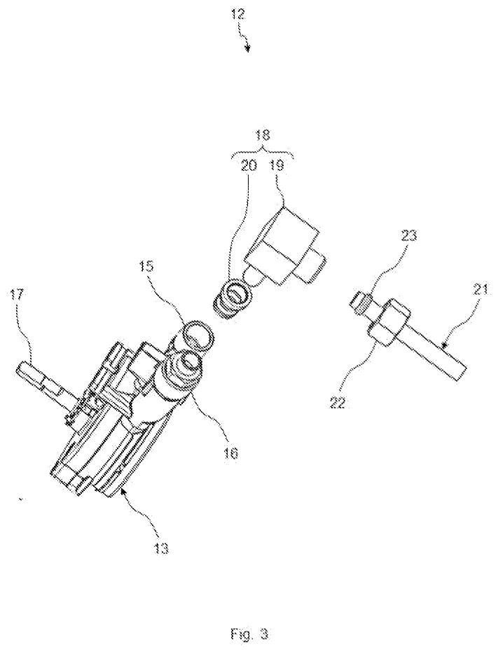

FIG. 3 shows a perspective exploded view of an embodiment of a gas valve arrangement for the gas stove according to FIG. 2;

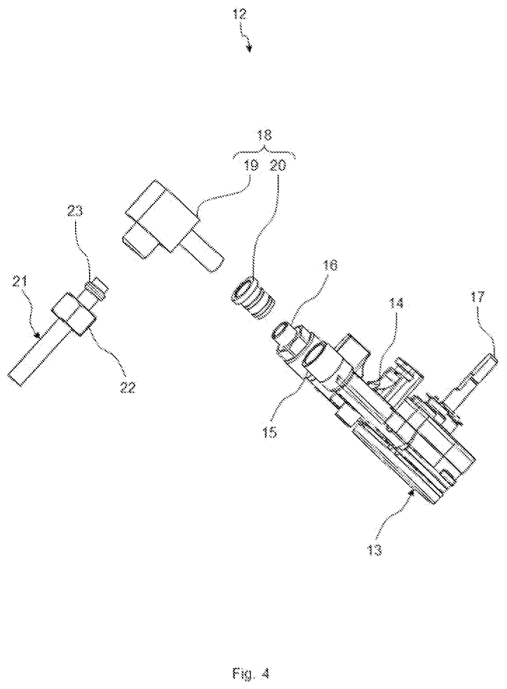

FIG. 4 shows another perspective exploded view of the gas valve arrangement according to FIG. 3;

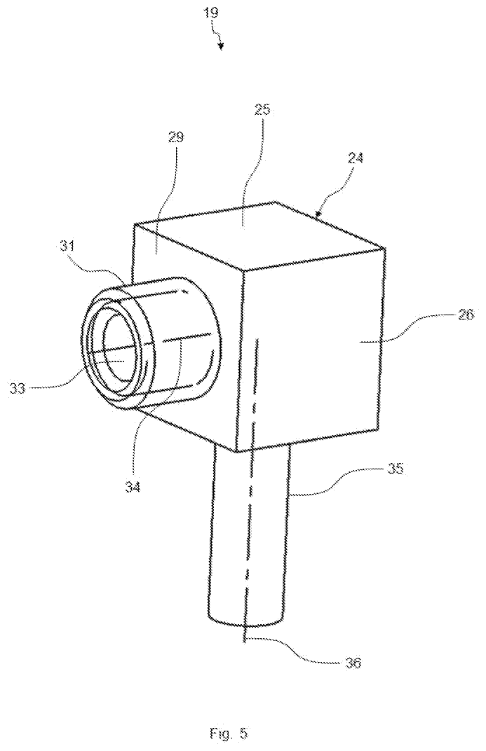

FIG. 5 shows a perspective view of an embodiment of a manifold for the gas valve arrangement according to FIG. 3;

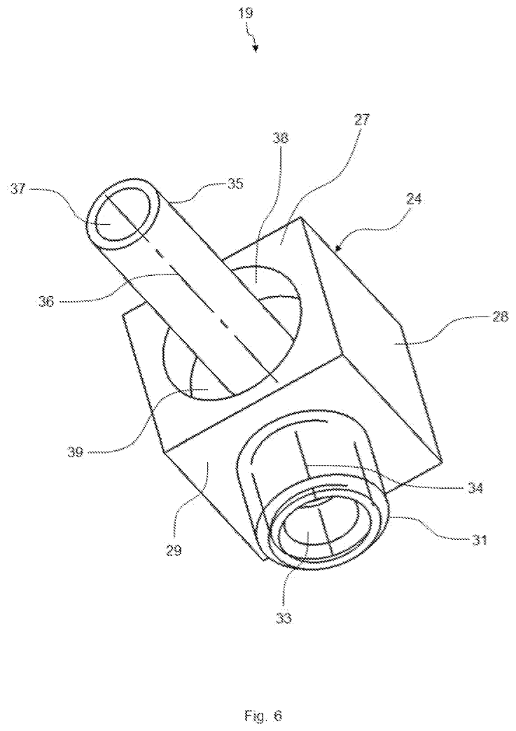

FIG. 6 shows another perspective view of the manifold according to FIG. 5;

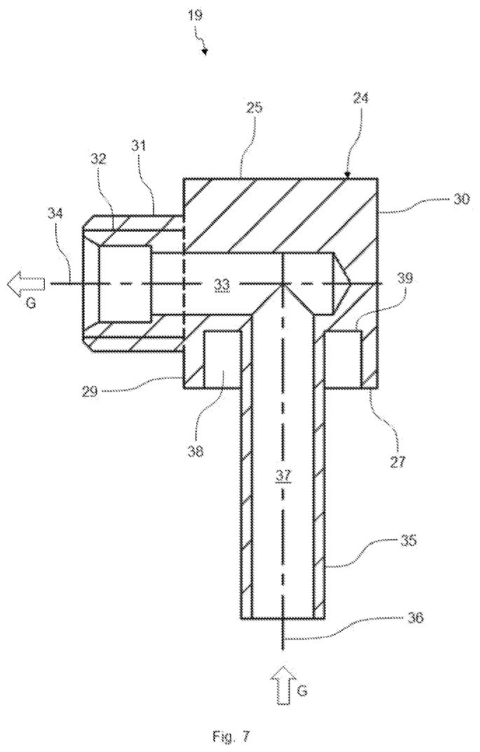

FIG. 7 shows a cross-sectional view of the manifold according to FIG. 5; and

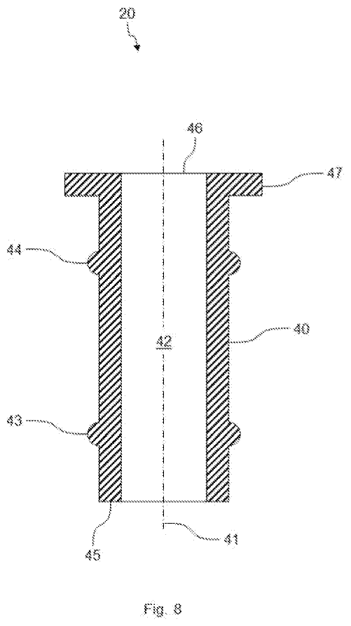

FIG. 8 shows a cross-sectional view of an embodiment of a gasket for the gas valve arrangement according to FIG. 3.

In the Figures, like reference numerals designate like or functionally equivalent elements, unless otherwise indicated.

FIG. 1 shows a schematic top view of an embodiment of a gas hob or gas stove 1A. The gas stove 1A can be a household appliance or part of a household appliance. The gas stove 1A comprises a plurality of gas burners 2 to 5. The number of gas burners 2 to 5 is arbitrary. As FIG. 1 shows, there can be provided four gas burners 2 to 5. The gas burners 2 to 5 protrude over a top sheet 6 of the gas stove 1A. The top sheet 6 can be a glass or glass ceramic plate. However, the top sheet 6 can also be a steel sheet.

The gas stove 1A has a plurality of knobs 7 to 10. Each knob 7 to 10 belongs to a gas valve (not shown). The number of knobs 7 to 10 is the same as the number of gas burners 2 to 5. Each knob 7 to 10 is assigned to one gas burner 2 to 5. By means of the knobs 7 to 10, a stream of combustion gas from a main gas pipe to the assigned gas burner 2 to 5 can be controlled continuously or stepwise.

FIG. 2 shows a schematic front view of another embodiment of a gas hob or gas stove 1B. The gas stove 1B can be a household appliance or part of a household appliance. The gas stove 1B differs from the gas stove 1A only in that the knobs 7 to 10 are not provided on top of the gas stove 1A but on a front panel 11. The front panel 11 is arranged perpendicular to the top sheet 6.

FIGS. 3 and 4 both show exploded perspective views of an embodiment of a gas valve arrangement 12 for the gas stove 1B. In the following, FIGS. 3 and 4 will be referred to at the same time. The gas valve arrangement 12 comprises a gas valve 13. The gas valve 13 is attached to a main gas pipe (not shown). The gas valve 13 is a gas regulating valve. The gas valve 13 is suitable for regulating a stream of combustion gas from the main gas pipe to the assigned gas burner 2 to 5 continuously or stepwise. In particular, the gas valve 13 is a so-called step valve. The gas valve 13 is preferably clamped to the main gas pipe.

The gas valve 13 has a gas inlet 14 that is connected to the main gas pipe. The gas valve 13 further has a tube-shaped gas outlet 15. The gas outlet 15 can be connected to one of the gas burners 2 to 5. The gas outlet 15 has an outer thread. Besides the gas outlet 15, the gas valve 13 has a tube-shaped thermoelement connector 16. A thermoelement (not shown) can be connected to the gas valve 13 by means of the thermoelement connector 16. Each gas burner 2 to 5 has a thermoelement. The thermoelements are used for supervising a flame of the respective gas burner 2 to 5. If the flame expires, the thermoelement cools down sending a signal to the gas valve 13 to shut down the gas flow to the gas burner 2 to 5.

An actuation stem 17 of the gas valve 13 can be rotated to adjust the gas flow from the gas valve 13 to the gas burner 2 to 5. One of the knobs 7 to 10 is mounted to the actuation stem 17. The actuation stem 17 is arranged perpendicular to the gas outlet 15. This means that the gas outlet 15 is arranged in an angle of 90° relative toward the actuation stem 17.

The gas valve 13 according to FIGS. 3 and 4 is suitable for the gas stove 1A. For the gas stove 1B, gas valves (not shown) with an angle between the gas outlet 15 and the actuation stem 17 of 180° are necessary because the gas outlet 15 and the actuation stem 17 both need to be arranged horizontal. This means that the two types of gas stoves 1A, 1B need different types of gas valves 13. However, it is desirable to use the same type of gas valve 13 for both types of gas stoves 1A, 1B.

To achieve this goal, the gas valve arrangement 12 has an elbow device or manifold device 18 which is configured to redirect or deflect the stream of combustion gas by 90°. The manifold device 18 comprises a manifold 19 and a gasket 20. The gasket 20 is made of a flexible material like rubber. The manifold device 18 is arranged between the gas outlet 15 and a tube 21. The tube 21 connects the manifold device 18 to the corresponding gas burner 2 to 5. The tube 21 can be an aluminum tube. The tube 21 comprises a cap nut 22 and a cutting ring 23. By means of the cap nut 22 and the cutting ring 23, the tube 21 can be directly connected to the gas outlet 15. However, to deflect the combustion gas by 90°, the tube 21 is connected to the manifold device 18 as will be explained in the following.

FIGS. 5 and 6 both show perspective views of the manifold 19. FIG. 7 shows a cross-sectional view of the manifold 19. In the following, FIGS. 5 to 7 will be referred to at the same time. The manifold 19 is configured to redirect or deflect a stream of combustion gas G (FIG. 7) by 90°. The manifold 19 can be made of metal like steel or aluminum. However, the manifold 19 can also be made of a plastic material. The manifold 19 has a box-shaped or cube-shaped base section 24. The base section 24 has six outer faces 25 to 30. A cylinder-shaped fastening section 31 protrudes from the outer face 29. The fastening section 31 has an outer thread 32 (FIG. 7). The cap nut 22 of the tube 21 can be screwed onto the fastening section 31.

A central bore 33 protrudes throughout the fastening section 31 into the base section 24. The bore 33 is stepped and can receive the tube 21 and the cutting ring 23. The bore 33 is designed rotation symmetric toward an axis of symmetry 34.

A tube-shaped connection section 35 protrudes from the outer face 27. The connection section 35 is designed rotation symmetric toward an axis of symmetry 36. The axis of symmetry 34 and the axis of symmetry 36 are arranged perpendicular. The connection section 35 has a central bore 37 that intersects the bore 33. Thus, the bores 33, 37 are connected to each other in a fluidic way. That means that the combustion G gas can flow from the bore 37 into the bore 33 or vice versa. The outer face 27 has an annular groove 38 that runs around the connection section 35. The annular groove 38 has a bottom face 39 that is set back behind the outer face 27.

FIG. 8 shows a cross-sectional view of the gasket 20. The gasket 20 is made of a flexible material like rubber. The gasket 20 is integrally formed. The gasket 20 has a tube-shaped base section 40 that is designed rotation symmetric toward an axis of symmetry 41. The base section 40 has a central bore 42 that can receive the connection section 35. The base section 40 has a first ring section 43 and a second ring section 44. The ring sections 43, 44 have a semicircular shape. When seen along the axis of symmetry 41, the ring sections 43, 44 are spaced apart.

The base section 40 has a first face 45 and a second face 46 that faces away from the first face 45. The second face 46 lies against the bottom face 39 of the annular groove 38 of the manifold 19. The bore 42 breaks through both faces 45, 46. At the second face 46, a flange section 47 radially protrudes from the base section 40. The flange section 47 has a bigger diameter than the base section 40. The flange section 47 can be received in the annular grove 38 of the manifold 19.

The functionality of the manifold device 18 is described in the following. The gasket 20 is plugged on the tube-shaped connection section 35 of the manifold 19. Thereby the flange section 47 is received in the annular groove 38. The face 46 of the flange section 47 lies against the bottom face 39 of the annular groove 38.

The connection section 35 together with the gasket 20 is plugged into the gas outlet 15 of the gas valve 13. The tube-shaped gas outlet 15 can be partly received in the annular groove 38. The two ring sections 43, 44 seal against the gas outlet 15 in a fluid-tight manner. Two ring sections 43, 44 provide excellent sealing properties compared to a solution with less than two ring sections 43, 44.

The manifold 19 is held to the gas outlet 15 by friction between the connection section 35 and the gasket 20 as well as friction between the gasket 20 and the gas outlet 15. A screw connection between the manifold 19 and the gas outlet 15 is therefore needless. This enables an automated assembling of the gas valve arrangement 12. No additional space for a screw connection is needed.

The tube 21 is connected by means of the cap nut 22 and the cutting ring 23 to the fastening section 31 of the manifold 19. Alternatively, the tube 21 can be connected to the manifold 19 before the manifold 19 is attached to the gas outlet 15 of the gas valve 13.

By means of the manifold device 18 it is possible to use one type of gas valve 13 for different types of gas stoves 1A, 1B. Namely a gas stove 1A which has the knobs 7 to 10 on top of the gas stove 1A as well as a gas stove 1B which has the knobs 7 to 10 on a front of the gas stove 1B. Furthermore, it is possible to use more common references for different types of gas stoves 1A, 1B. Development times and costs can be reduced. One solution for the gas valve 13 can be used for different product variants of the gas stove 1A, 1B.

Although the present invention has been described in accordance with preferred embodiments, it is obvious for the person skilled in the art that modifications are possible in all embodiments.

### REFERENCE NUMERALS

1A Gas stove
1B Gas stove
2 Gas burner
3 Gas burner
4 Gas burner
5 Gas burner
6 Top sheet
7 Knob
8 Knob
9 Knob
10 Knob
11 Front panel
12 Gas valve arrangement
13 Gas valve
14 Gas inlet
15 Gas outlet
16 Thermoelement connector
17 Actuation stem
18 Manifold device
19 Manifold
20 Gasket
21 Tube
22 Cap nut
23 Cutting ring
24 Base section
25 Outer face
26 Outer face
27 Outer face
28 Outer face
29 Outer face
30 Outer face
31 Fastening section
32 Outer thread
33 Bore
34 Axis of symmetry
35 Connection section
36 Axis of symmetry
37 Bore
38 Annular groove
39 Bottom face
40 Base section
41 Axis of symmetry
42 Bore
43 Ring section
44 Ring section
45 Face
46 Face
47 Flange section
G Combustion gas

1-15. (canceled)

16. A gas valve arrangement for a gas stove, said gas valve arrangement comprising:
a gas valve including a gas inlet and a gas outlet; and
a manifold device designed to redirect a flow of combustion gas from the gas outlet by 90°, said manifold device being attached to the gas outlet solely by friction.

17. The gas valve arrangement of claim 16, wherein the gas valve comprises an actuation stem for actuating the gas valve, said actuation stem and said gas outlet being arranged perpendicular to each other.

18. The gas valve arrangement of claim 16, wherein the manifold device comprises a manifold designed to redirect the flow of combustion gas by 90°.

19. The gas valve arrangement of claim 18, wherein the manifold comprises a fastening section designed for connection of a tube, and a connection section designed to be at least partly received in the gas outlet, with the fastening section and the connection section being arranged perpendicular to each other.

20. The gas valve arrangement of claim 19, wherein the fastening section comprises an outer thread.

21. The gas valve arrangement of claim 19, wherein the connection section has a smooth exterior surface.

22. The gas valve arrangement of claim 19, wherein the fastening section comprises a central bore, said connection section comprising a central bore, with the central bore of the fastening section and the central bore of the connection section intersecting each other.

23. The gas valve arrangement of claim 19, wherein the manifold comprises a box-shaped base section with outer faces, with the fastening section protruding from one of the outer faces, and with the connection section protruding from another one of the outer faces.

24. The gas valve arrangement of claim 23, wherein the base section comprises an annular groove which runs around the connection section.

25. The gas valve arrangement of claim 19, wherein the manifold device comprises a gasket designed to receive the connection section.

26. The gas valve arrangement of claim 25, wherein the gasket is designed to attach the manifold device to the gas outlet solely by friction.

27. The gas valve arrangement of claim 25, wherein the gasket is made of a flexible material.

28. The gas valve arrangement of claim 25, wherein the gasket is made of rubber.

29. The gas valve arrangement of claim 25, wherein the gasket comprises a ring section which runs around the gasket for sealing the gasket against the gas outlet.

30. The gas valve arrangement of claim 25, wherein the gasket comprises a flange section which runs around the gasket and which is at least partly received within the manifold.

31. A gas stove, comprising a gas valve arrangement, said gas valve arrangement comprising a gas valve including a gas inlet and a gas outlet, and a manifold device designed to redirect a flow of combustion gas from the gas outlet by 90°, said manifold device being attached to the gas outlet solely by friction.
